(19) United States
(12) Patent Application Publication
(10) Pub. No.: US 2005/0007782 A1
(43) Pub. Date: Jan. 13, 2005

(54) Lighting system for vending machine

(75) Inventors: William D. Denison, Lake Zurich, IL (US); Calin Vasile Roatis, Des Plaines, IL (US); Gary L. Myers, Monee, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: TriTeq Lock and Security, L.L.C., Elk Grove, IL (US)

(21) Appl. No.: 10/616,656

(22) Filed: Jul. 10, 2003

(51) Int. Cl. H01R 33/00

(52) U.S. Cl. 362/263

(57) ABSTRACT

A neon lighting system for an illuminated vending machine or the like includes a neon tube having projecting conducting leads from each of its ends; conductive end caps sealingly affixed to said tube ends in contact with said leads and forming plug ends for the tube; power supply conductor wires have boot ends containing receptacles connected to said wires; and are adapted to snap on to and off from the tube plug end caps for quick placement and replacement of the neon tube. The boot ends are preferably formed with holding means for quick attachment and removal from brackets provided on the machine door structure.

### FIELD OF THE INVENTION

This invention relates generally to lighting systems for structures such as vending machines, and more particularly, to a neon lighting system for vending machines with a quick-change neon light bulb.

### BACKGROUND OF THE INVENTION

Illuminated vending machines are now widely used and present in many locations throughout the world. Typically, interior fluorescent lamps are being used for the source of illumination, although it has been recognized that other sources of illumination such as neon might offer benefits and cost savings as compared to fluorescent lighting.

Reference may be made, for example, to U.S. Patent Application Publication No. US 2002/0159246A1, published Oct. 31, 2002 and U.S. Pat. No. 6,259,211 dated Jul. 10, 2001. While neon lighting in principle offers many benefits over fluorescent in terms of energy conservation, longevity, and cost savings on maintenance, it has not replaced use of fluorescent lighting in the vending machine field for several reasons. New types of solid state and GFCI transformers have overcome certain problems in that area preventing use of neon lamps. Other problems previously presented by neon systems have likewise sought to have been addressed in U.S. Pat. Nos. 5,145,248 and 6,419,374. Yet, neon lighting systems have not significantly found their way into the vending machine industry.

Accordingly, the present invention provides the solution to the problems associated with neon lighting as a replacement for fluorescent lamps and alleviates the reasons for avoiding neon lamps associated with the ease of replacement and installation of neon lamps in applications such as vending machine illumination.

### SUMMARY OF THE INVENTION

In accordance with the preferred embodiment of the invention, a neon lamp or tube is fitted with end cap plug connectors that can receive snap-on receptacle contact members which in turn are insertable into and removable from housing bracket holders so that a quick installation and removal of the neon tube is possible. The combination of the tube plug end caps, coupling of the power receptacle connection to the neon tubes and the bracket mounting enables the easier changeover and replacement of neon bulbs or tubes suitable for use in vending machines, therefore, solving and eliminating any resistance against use of neon instead of fluorescent lighting.

These and other objects and benefits will become apparent from the following description of a preferred embodiment taken together with the accompanying drawings and the appended claims.

### BRIEF DESCRIPTION OF THE DRAWINGS

FIG. 1 is an exemplary Prior Art showing of the manner in which neon lamps or tubes have been connected typically to the transformer or power supply (not shown);

FIG. 2 is a perspective view of an illustrative vending machine with a behind the door lighting system useful for the present invention;

FIG. 3 is a side view partly in section illustrating our new connecting and mounting system for neon tube lighting in a vending machine such as in FIG. 2

### DETAILED DESCRIPTION OF THE INVENTION

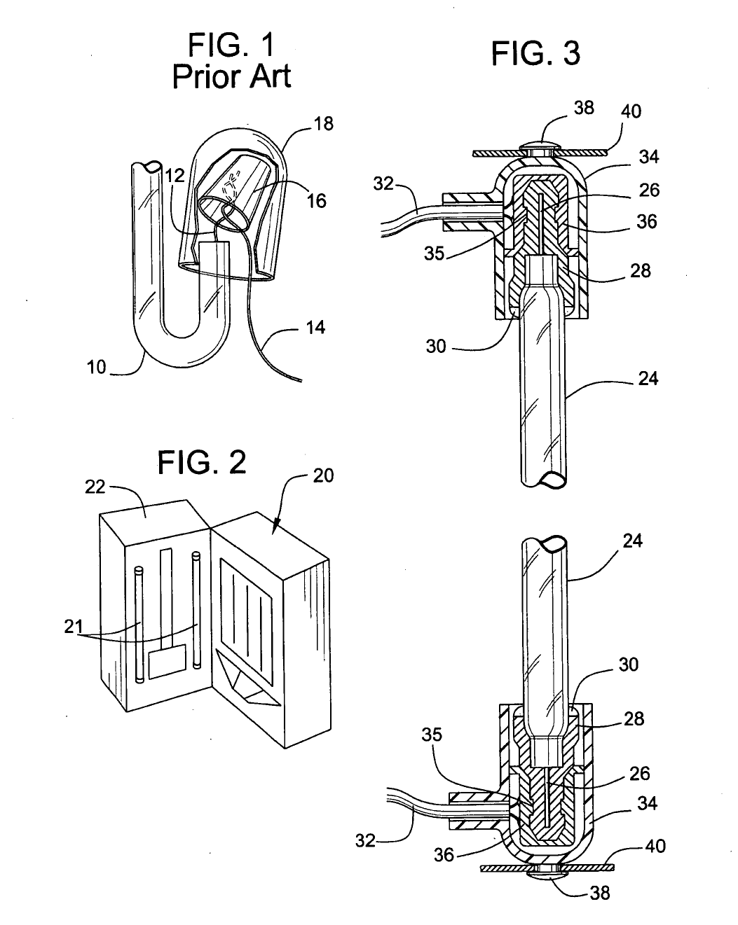

Referring now to the drawings, there is illustrated in FIG. 1, the typical manner of connection in the prior art in which a neon tube 10 with its conducting lead 12 has been connected to the power supply or transformer lead wire 14 such as in commonly used signs and displays. The wires 12,14 have simply been twisted together and secured by an insulation cap or wire nut 16. An over boot or shrink cover 18 seals it off and also provided the aesthetic aspects of the installation. Since neon signs, displays and lighting systems commonly employed often last for so long that tube or bulb changing is not a real concern and even then it is left to the experts such as a sign company the FIG. 1 type of connection sufficed. However, in a vending machine 20, such as illustrated in FIG. 2, the lighting 21 is typically mounted behind the front panel in the rear of the door 22 and access is not available beyond the machine operators. Changing bulbs or lamps need not require expertise or any more than what is currently available with use of fluorescent lamps, while obtaining the benefits available with use of neon lighting systems.

In accordance with the present invention, referring to FIG. 3, there is shown a neon lamp or tube 24 that has internal electrodes (not shown) and conducting leads 26 provided with conductive end caps 28 that are sealingly affixed to the tubes with an adhesive sealant 30. The end caps 28 present a plug-like connector.

In order to provide a quick connect and disconnect for the neon tube 24, the power supply or transformer leads 32 have a flexible and preferably heat resistant end boot 34 which covers a snap on receptacle 36 connected to the wire end of lead 32. The arrangement is such that the boot covered receptacle can be quickly snapped on or off the plug ends of the neon tube for replacement. This is here presented by a mating tongue and groove 35 on respective ones of the plug and receptacle elements 28,36.

In accordance with another feature of the invention, the boot 34 may be provided with an integral holding portion 38, which as here shown, is mushroom or rivet shaped element and it can easily be snapped into or removed from a pair of spaced bracket members 40 which can be affixed inside the door structure of a vending machine in the manner illustratively shown in FIG. 2. The brackets 40 may have a slot so that the holding portion 38 may be slid in and out from the brackets.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A neon lighting system for an illuminated vending machine or the like comprising a neon tube having projecting conducting leads from each of its ends;
conductive end caps sealingly affixed to said tube ends in contact with said leads and forming plug ends for said tube;
power supply conductor wires having boot ends containing receptacles connected to said wires; and
said receptacles being adapted to snap on to and off from the tube plug end caps for quick placement and replacement of the neon tube.

2. A neon lighting system as claimed in claim 1 wherein said power supply boot ends are made of flexible and heat resistant material.

3. A neon lighting system as claimed in claim 2 wherein said boot ends include integrally formed holding means for supporting the connected neon tube.

4. A neon lighting system as claimed in claim 3 wherein bracket means are provided in the vending machine and said brackets are adapted to removably receive the holding means on said boot ends.

5. A neon lighting system is claimed in claim 4 wherein said brackets are spaced apart to receive respective ends of the wire boot connected neon tube.

6. A method of illuminating a vending machine or the like with neon tubular lamps comprising;
forming neon tubular lamps with conductive plug means sealingly affixed to the ends of the lamp tube;
providing booted end receptacles for power supply wires adapted to snap onto and off from the end plug means on the neon tubular lamp; and
providing holding means within the machine structure adapted to removingly receive the booted neon tubular lamp for retaining it in position for illumination and quick removal for changing and replacement to the neon tubular lamp.

7. The method of claim 6 wherein the step of retaining the booted ends of the power supply wires includes forming retaining means on the boots adapted to be removably received by the brackets affixed to the machine.

8. The method of claim 7 wherein the brackets are spaced apart and slidingly receive the holding means formed on the boot ends of the power supply wires.

9. The method of claim 7 wherein the brackets slidably receive the boot retaining means.

10. The method of claim 6 wherein the snap on and off connection between the end plugs and boot receptacles employs a tongue and groove.
